(19) United States
(12) Patent Application Publication
(10) Pub. No.: US 2006/0273590 A1
(43) Pub. Date: Dec. 7, 2006

(54) Hose clamp retaining cap

(76) Inventors: Kishor V. Borkar, Pune (IN); G. Michael Wooley, Grosse Pointe Woods, MI (US); Anthony J. Tundo, Clinton Township, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/144,459

(22) Filed: Jun. 3, 2005

(51) Int. Cl. F16L 25/00

(52) U.S. Cl. 285/420

(57) ABSTRACT

A retaining cap for holding a hose clamp on a hose is provided that includes a resiliently-deformable body member sized for placement over an expanded hose clamp such that the expanded hose clamp is positioned between the body member and a hose. The retaining cap also includes at least two hose-engaging members connected to the body member and adapted to engage the hose and apply inwardly directed pressure to hold the retaining cap and the expanded hose clamp on the hose. A method of holding a hose clamp to a hose is also provided.

### BACKGROUND OF THE INVENTION

1. Field of the Invention

The present invention relates to a hose clamp retaining cap for holding an expanded hose clamp on a hose.

2. Description of the Related Art

Automotive manufacturers utilize flexible hoses in their vehicles to transmit various fluids and gases. Many of these hoses are connected to the vehicle by means of a clamping device, otherwise referred to as a hose clamp or constant tension clamp. In areas where engine or vehicle components are in close proximity to one another, a substantial amount of labor may be expended to position the hose clamp in a desired manner if it is not previously attached to the hose. Therefore, hose suppliers to the automotive manufacturers typically supply their hose with attached clamps to assist in assembly. While traditional methods of attaching the clamps, such as gluing the clamps to the hose or applying a polymer shrink sleeve over the clamp, have proven successful, these methods can be costly and add undesirable complexity to the hose manufacturing process. For at least these reasons, improved hose clamp assemblies and methods of holding hose clamps on a hose are desired.

### SUMMARY OF THE INVENTION

A retaining cap for holding a hose clamp to a hose is provided that includes a resiliently-deformable body member sized for placement over an expanded hose clamp such that the expanded hose clamp is positioned between the body member and a hose. The retaining cap also includes at least two hose-engaging members connected to the body member and adapted to engage the hose and apply inwardly directed pressure to hold the retaining cap and the expanded hose clamp on the hose. A hose clamp assembly, a hose assembly, and method of holding a hose clamp on a hose are also provided. Other aspects of the invention will be apparent to those skilled in the art after review of the drawings and detailed description provided below.

### BRIEF DESCRIPTION OF THE DRAWINGS

Embodiments of the invention will now be described, by way of example, with reference to the accompanying drawings, wherein:

FIG. 1 is an exploded perspective view of a hose assembly according to an embodiment of the present invention;

FIG. 2 is a side view of the retaining cap of FIG. 2;

FIG. 3 is a top view of the retaining cap of FIG. 2;

FIG. 4 is a bottom view of the retaining cap of FIG. 2;

FIGS. 5-8 are perspective views of a method of holding a hose clamp to a hose according to an embodiment of the present invention;

FIG. 9 is an assembled perspective view of the hose assembly of FIG. 1; and

FIG. 10 is a perspective view of a method of removing a retaining cap once a hose clamp has been contracted around a hose.

### DETAILED DESCRIPTION

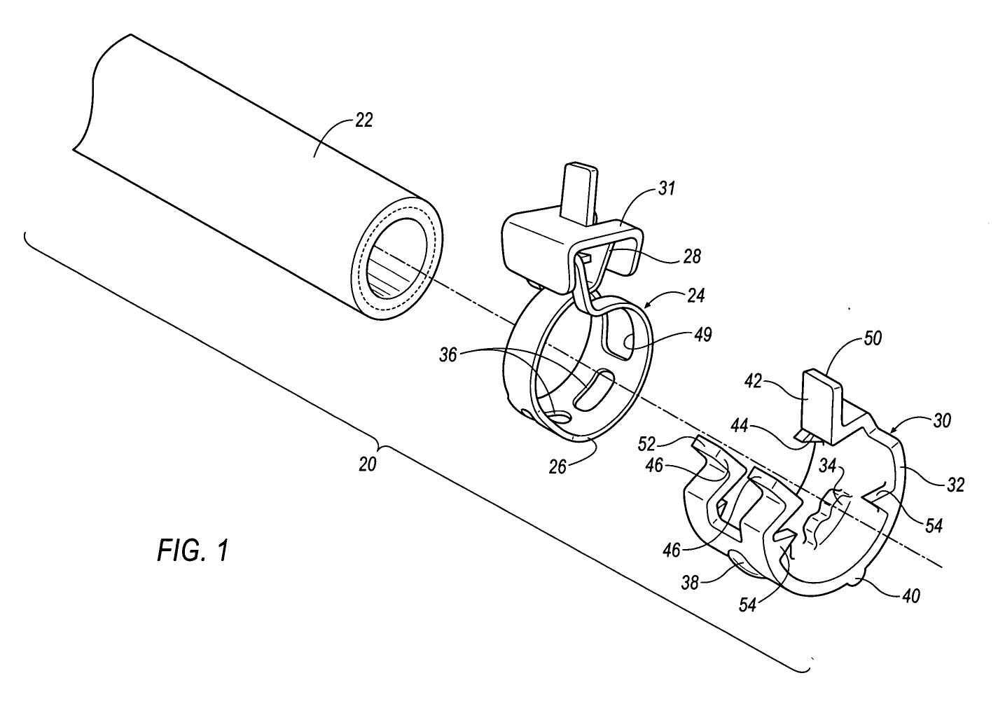

Referring to FIG. 1, a hose assembly 20 is shown that includes a hose 22, an expandable hose clamp 24 having a clamping portion 26 and an expanding portion 28, and a retaining cap 30 for holding hose clamp 24 on hose 22 prior to contracting hose clamp 24 around hose 22. To facilitate assembly, expanding portion 28 may include a removable clip 31 that holds hose clamp 24 in the expanded state shown in FIG. 1.

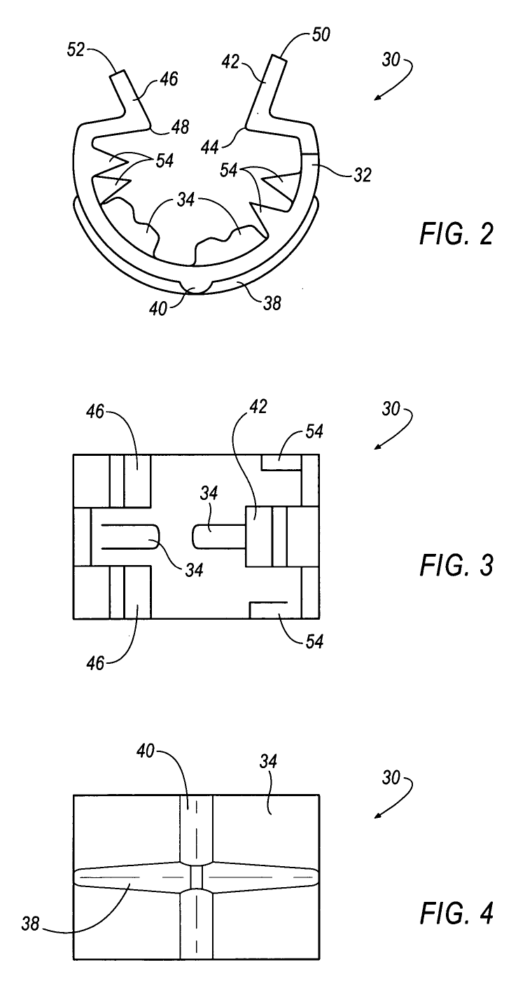

In the embodiment illustrated in FIGS. 2-4, retaining cap 30 includes a resiliently-deformable body member 32 sized for placement over clamping portion 26 of expandable hose clamp 24 such that the expandable hose clamp is positioned between body member 32 and hose 22. As will be described in further detail below, retaining cap 30 also includes at least two hose-engaging members adapted to engage hose 22 and apply inwardly directed pressure to hold retaining cap 30 and hose clamp 24 on hose 22 until hose clamp 24 can be contracted around hose 22.

As shown in the embodiment of FIGS. 1-4, body member 32, which may be made from a resilient material such as metal or plastic, is generally semicircular or otherwise shaped to accommodate the contour of clamping portion 26. Body member 32 may also include at least one protrusion 34 that extends through an aperture 36 (see, e.g., FIG. 1) in hose clamp 24 to locate retaining cap 30 over hose clamp 24 and to substantially inhibit movement of hose clamp 24 relative to retaining cap 30. An outer surface of body member 32 may include an optional circumferentially-extending rib 38 to reinforce body member 32 during deformation and an optional axially extending rib 40 to assist in ejecting retaining cap 30 from an injection mold if so manufactured.

In an embodiment, the hose-engaging members of retaining cap 30 include a first leg 42 having a first hose-engaging ridge 44 and a second leg 46 having a second hose-engaging ridge 48. In the illustrated configuration, first leg 42 extends through an aperture 49 in hose clamp 24 adjacent a first end 50 of body member 32 to contact hose 22. When no aperture 49 is available, retaining cap 30 may include pair of second legs 46 that straddle hose clamp 24 adjacent a second end 52 of body member 32 to contact hose 22. Given the resiliency of the retaining cap material, each of legs 42, 46 apply inwardly directed pressure to hose 22 to hold retaining cap 30 and expanded hose clamp 24 on hose 22.

Referring still to FIGS. 2-4, the hose-engaging members may also include a barb 54 positioned between first and second ends 50, 52 of body member 32. As legs 42, 46 apply inwardly directed pressure to hose 22, barb 54 grips hose 22 and substantially inhibits axial movement of retaining cap 30 and hose clamp 24 relative to hose 22.

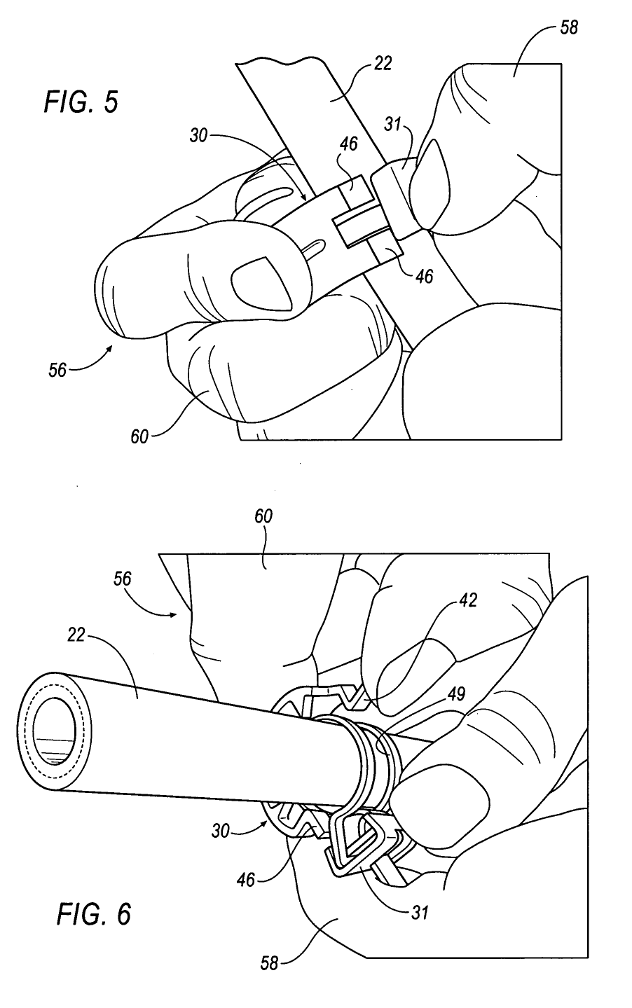

A method of holding a hose clamp on a hose will now be described with reference to FIGS. 5-9. In an embodiment, a length of hose 22, an expandable hose clamp 24 and a retaining cap 30 are provided for assembly. Hose clamp 24 may be held expanded using clip 31 and then slid over hose 22. Since the inner diameter of hose clamp 24 is greater than the outer diameter of hose 22, clamp 24 is free rotate and move axially over hose 22.

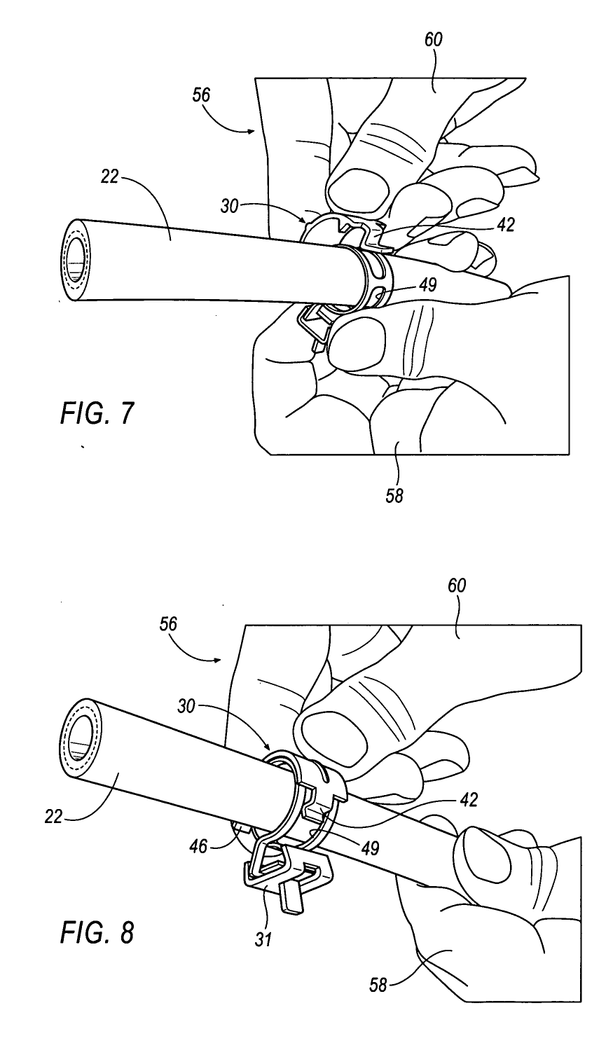

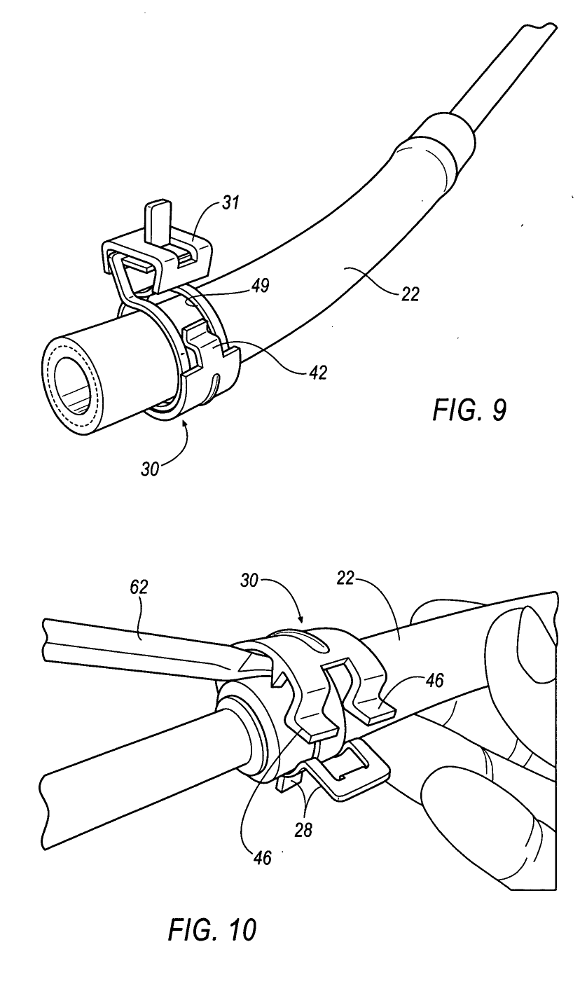

Next, while an assembler 56 generally holds hose 22 and clip 31 with one hand 58, second legs 46 are moved into engagement with the outer surface of hose 22 and held in place using the same hand 58 generally holding hose 22 and clip 31 (see, e.g., FIG. 5). Using the assembler's other hand 60, a small amount of pressure may then be applied to first leg 42 causing body member 32 to deform (e.g., expand) as first leg 42 moves away from second legs 46 (see, e.g., FIGS. 6 and 7). First leg 42 is then slid over and around hose clamp 24 until first leg 42 is aligned with aperture 49 in hose clamp 24 (see, e.g., FIG. 8). Body member 32 is then permitted to contract, causing first leg 42 to engage hose 22 through aperture 49 in hose clamp 24 (see, e.g., FIG. 9). As first leg 42 slides into aperture 49, an audible “click” or other sound may be generated providing an indication that assembly is complete. If desired, retaining cap 30 may be slightly rotated over hose 22 to ensure retaining cap 30 and hose clamp 24 are properly positioned over hose 22.

Once clip 31 is removed and hose clamp 24 is contracted over hose 22, retaining cap 30 may be removed by gripping second legs 46 and deforming (e.g., expanding) body member 32 over clamp 24 and hose 22. Alternatively, as shown in FIG. 10, a tool 62, such as a screwdriver and the like, may be inserted between retaining cap 30 and hose clamp 24 to expand and/or pry retaining cap 30 off of hose clamp 24. After removal, there is generally no damage to retaining cap 30, allowing retaining cap 30 to be reused.

It will be appreciated that the above-described retaining cap and method of holding a hose clamp on a hose are not limited to the hose 22 and hose clamp 24 configured illustrated in the drawings. It will also be appreciated that the steps taken to assemble retaining cap 30 on hose 22 are not limited to the hand-method described above, and that more automated assembly methods are within the scope of the present invention.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A retaining cap for holding a hose clamp on a hose, comprising:
a resiliently-deformable body member sized for placement over an expanded hose clamp such that the expanded hose clamp is positioned between the body member and a hose;
at least two hose-engaging members connected to the body member and adapted to engage the hose and apply inwardly directed pressure to hold the retaining cap and the expanded hose clamp on the hose.

2. The retaining cap of claim 1, wherein the body member includes at least one protrusion that extends through an aperture in the hose clamp to position or locate the retaining cap over the hose clamp and to substantially inhibit movement of the hose clamp relative to the retaining cap.

3. The retaining cap of claim 1, wherein an outer surface of the body member includes at least one reinforcing rib.

4. The retaining cap of claim 1, wherein the hose-engaging members include a first leg having a first hose-engaging ridge and a second leg having a second hose-engaging ridge.

5. The retaining cap of claim 1, wherein the hose-engaging members include a first leg that extends through an aperture in the hose clamp adjacent a first end of the body member and a pair of second legs that straddle the hose clamp adjacent a second end of the body member.

6. The retaining cap of claim 1, wherein the hose-engaging members include a barb positioned between first and second ends of the body member.

7. The retaining cap of claim 1, wherein the body member is generally semicircular.

8. A hose clamp assembly, comprising:
an expandable hose clamp having a clamping portion and an expanding portion; and
a retaining cap including a resiliently-deformable body member sized for placement over the clamping portion of the expandable hose clamp such that the expandable hose clamp is positioned between the body member and a hose, and at least two hose-engaging members adapted to engage the hose and apply inwardly directed pressure to hold the retaining cap and the expanded hose clamp on the hose.

9. The assembly of claim 8, wherein the expanding portion includes a clip that holds the hose clamp in an expanded state.

10. The assembly of claim 8, wherein the body member includes at least one protrusion that extends through an aperture in the hose clamp to locate the retaining cap over the hose clamp and to inhibit movement of the hose clamp relative to the retaining cap.

11. The assembly of claim 8, wherein an outer surface of the body member includes at least one reinforcing rib.

12. The assembly of claim 8, wherein the hose-engaging members include a first leg having a first hose-engaging ridge and a second leg having a second hose-engaging ridge.

13. The assembly of claim 8, wherein the hose-engaging members include a first leg that extends through an aperture in the hose clamp adjacent a first end of the body member and a pair of second legs that straddle the hose clamp adjacent a second end of the body member.

14. The assembly of claim 8, wherein the hose-engaging members include a barb positioned between first and second ends of the body member.

15. The assembly of claim 8, wherein the body member is generally semicircular.

16. A hose assembly, comprising:
a hose;
an expanded hose clamp having a clamping portion and an expanding portion; and
a retaining cap including a resiliently-deformable body member sized for placement over the clamping portion of the expanded hose clamp such that the expanded hose clamp is positioned between the body member and the hose, and at least two hose-engaging members adapted to engage the hose and apply inwardly directed pressure to hold the retaining cap and the hose clamp to the hose.

17. The assembly of claim 16, wherein the expanding portion includes a clip that holds the hose clamp in the expanded state.

18. The assembly of claim 16, wherein the body member includes at least one protrusion that extends through an aperture in the hose clamp to locate the retaining cap over the hose clamp and to inhibit movement of the hose clamp relative to the retaining cap.

19. The assembly of claim 16, wherein an outer surface of the body member includes at least one reinforcing rib.

20. The assembly of claim 16, wherein the hose-engaging members include a first leg having a first hose-engaging ridge and a second leg having a second hose-engaging ridge.

21. The assembly of claim 16, wherein the hose-engaging members include a first leg that extends through an aperture in the hose clamp adjacent a first end of the body member and a pair of second legs that straddle the hose clamp adjacent a second end of the body member.

22. The assembly of claim 16, wherein the hose-engaging members include a barb positioned between first and second ends of the body member.

23. The assembly of claim 16, wherein the body member is generally semicircular.

24. A method for holding a hose clamp to a hose comprising the steps of:
providing a hose, an expanded hose clamp and a retaining cap, the retaining cap including a resiliently-deformable body member sized for placement over the expanded hose clamp such that the expanded hose clamp is positioned between the body member and a hose, and at least two hose-engaging members connected to the body member and adapted to engage the hose and apply inwardly directed pressure to hold the retaining cap and the expanded hose clamp on the hose;
sliding the expanded hose clamp over the hose; and
placing the cap member over the expanded hose clamp so that the at least two hose-engaging members engage the hose and apply inwardly directed pressure to hold the retaining cap and expanded hose clamp on the hose.
